(19) United States
(12) Patent Application Publication
(10) Pub. No.: US 2014/0149132 A1
(43) Pub. Date: May 29, 2014

(54) ADAPTIVE MEDICAL DOCUMENTATION AND DOCUMENT MANAGEMENT

(71) Applicants: Jan DeHaan, Hawley, PA (US); John D. Haley, Chester Springs, PA (US); Alan Rector, Sheffield (GB); Sebastian Philipp Brandt, Manchester (GB); Samuel I. Brandt, Parker, CO (US); Luigi Iannone, London (GB); Nicholas Drummond, Stockport (GB)

(72) Inventors: Jan DeHaan, Hawley, PA (US); John D. Haley, Chester Springs, PA (US); Alan Rector, Sheffield (GB); Sebastian Philipp Brandt, Manchester (GB); Samuel I. Brandt, Parker, CO (US); Luigi Iannone, London (GB); Nicholas Drummond, Stockport (GB)

(21) Appl. No.: 14/087,365

(22) Filed: Nov. 22, 2013

Related U.S. Application Data
(63) Continuation-in-part of application No. 14/039,125, filed on Sep. 27, 2013.
(60) Provisional application No. 61/730,086, filed on Nov. 27, 2012.

(51) Int. Cl. G06F 19/00

(52) U.S. Cl. CPC G06F 19/324
USPC 705/2

(57) ABSTRACT

Managing clinical data documents may involve receiving hierarchically organized clinical document text of a plurality of different clinical documents comprised of text elements, text element qualifiers, and text element values. An analysis of the text elements, the text element qualifiers and the text element values of the received clinical documents may be performed. Clinical concepts in the received documents based on the analysis may be identified. An inventory of identified concepts may be generated. Clinical concepts may be combined to provide concept combinations, and a data structure model using the inventory and the concept combinations may be generated.

### RELATED APPLICATIONS

The present patent document claims the benefit of the filing date under 35 U.S.C. §119(e) of Provisional U.S. Patent Application Ser. No. 61/730,086, filed Nov. 27, 2012, which is hereby incorporated by reference, and the present patent document also claims the benefit under 35 U.S.C. §120 as a continuation-in-part of U.S. patent application Ser. No. 14/039,125 which is hereby also incorporated by reference.

### FIELD

The present embodiments relate to medical documentation customization. Specifically, the present embodiments relate to managing clinical data documents that may be used for automatic medical documentation adaptation for predicted or probable patient medical conditions.

### BACKGROUND

Medical entities acquire and store significant amounts of patient medical information for diagnosis and tracking purposes. Historically, this information was acquired using paper forms, filled out by patients or medical entity personnel. Also, medical entity personnel would need to know specifically which forms to provide to patients depending on the specific medical history, current condition of the patient, and any other information that may be relevant to medical care of the patient. Often, the multitude of forms actually used for a given patient would request the same information multiple times. These forms may then be stored in a paper file, for future references by medical entity personnel.

Electronic Medical Records (EMR) have become a standard storage technique for medical and health records for patients of medical practitioners and medical entities. EMRs contain a considerable amount of medical data for specific patients, from various sources and in various formats. Collections of EMRs for medical facilities provide medical records and history for most, if not all, patients in a medical entity.

The entry of data into an EMR, however, may still be a very complex issue involving the manual selection of proper electronic forms for particular patients. The number of medical forms stored to be used in such systems can be considerably large and managing the large number of forms may require significant resources. Further, many forms may be duplicate or near duplicate forms used for common clinical concepts in different settings or applications with minimal alterations. An existing clinical document or a section of a document may contain many topics with many sub topics. Multiple topics may be relevant at any one time for any one patient situation. Also, views of multiple forms may be needed, and creating and managing view combinations in known systems is a monumental task given the number of views that may be created. Medical facilities and medical entities face challenges in improving the quality of care for patients, as well as reducing costs and increasing revenue. Efficient and effective management of forms for entry and retrieval of information for medical systems and EMRs may aid in the pursuit of these goals by using resources allocated to the management of medical systems more efficiently.

### BRIEF SUMMARY

By way of introduction, the preferred embodiments described below include methods, computer readable media, and systems for managing documents for information intake, storage, and presentation. In a clinical environment, a system may have an existing library of forms that includes a significant number of existing forms relating to potential or existing conditions for patients. Some of these forms may be redundant, and only differ based on the specific application. The existing form library may be structured and condensed into a hierarchical information structure to simplify the management of information intake, storage, and presentation in a clinical data system. The resulting hierarchical information structure may be more efficient than existing form libraries.

In a first aspect, a system for centrally managing clinical data documents that transforms clinical document text of a plurality of different clinical document types into structured clinical data. The system involves an interface for receiving hierarchically organized clinical document text of a plurality of different clinical document types. The system may also involve a repository of information including clinical concepts and rules determining relationships between clinical concepts comprising text elements, text element qualifiers, and text element values. The system may also involve a document processor configured to use said information for analyzing text of the received documents to, identify clinical concepts in the received documents, generate an inventory of identified concepts, combine clinical concepts to provide concept combinations, and generate an information structure using the inventory and the concept combinations.

In a second aspect, a method for managing clinical data documents is presented. Hierarchically organized clinical document text of a plurality of different clinical documents comprised of text elements, text element qualifiers, and text element values may be received. An analysis of the text elements, the text element qualifiers and the text element values of the received clinical documents may be performed. Clinical concepts in the received documents may be identified based on the analysis. An inventory of identified concepts may be generated. Clinical concepts may be combined to provide concept combinations, and a data structure model may be generated using the inventory and the concept combinations.

In a third aspect, a system for managing clinical data documents involves at least one memory operable to store hierarchically organized clinical document text of a plurality of different clinical documents comprised of text elements, text element qualifiers and text element values, and a data structure model. The system may also involve at least one processor configured to perform an analysis of the text elements, the text element qualifiers and the text element values of the received clinical documents, identify clinical concepts in the received documents based on the analysis, generate an inventory of identified concepts, combine clinical concepts to provide concept combinations, and generate the data structure model using the inventory and the concept combinations.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a flow chart diagram of one embodiment of a method for adaptive medical data collection;

FIG. 2 is a flow chart diagram of another embodiment of a method for adaptive medical data collection;

FIG. 3 shows a flow chart diagram of an embodiment of a method for managing clinical data documents involving the generation of a data structure from existing clinical documents or forms;

FIG. 4 shows an example of a structured information hierarchy for use in a document model;

FIG. 5 shows a system for centrally managing clinical data documents;

FIG. 6 shows an example of a source map entry;

FIG. 7 shows an example of a document excerpt showing an element reference;

FIG. 8 shows an example clinical concept in a hierarchical data structure and an alternate translation that may be used in a structured knowledge model;

FIG. 9 shows example electronic document logic expressions;

FIG. 10 shows an example of an inventory of clinical concepts derived from existing clinical documents having duplicated elements;

FIG. 11 is a block diagram of one embodiment of a system for managing clinical data documents in for an adaptive electronic documentation system; and

FIG. 12 is a representation of an electronic medical record.

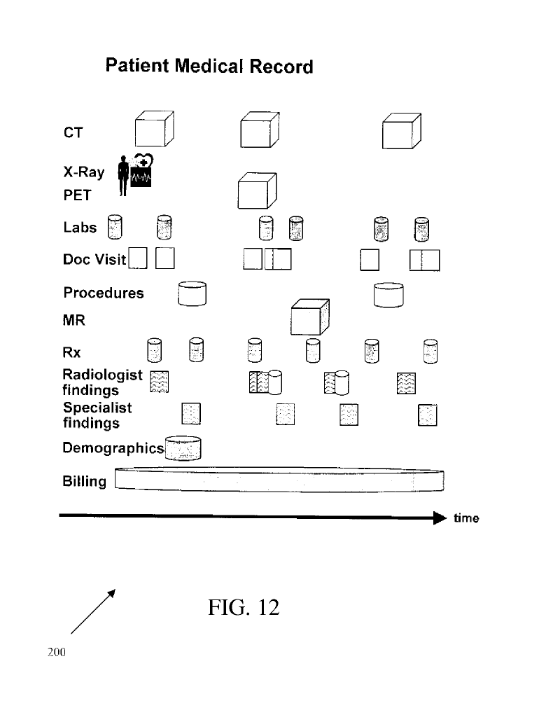

### DETAILED DESCRIPTION OF THE DRAWINGS AND PRESENTLY PREFERRED EMBODIMENTS

The collection of medical data for a patient may adapt to information input into an electronic medical record (EMR) of a patient. The collection adapts based on inferences and conclusions that can be made using existing knowledge of the patient and other clinical information sources. Information currently being input may be combined with prior patient information and the other clinical information sources to suggest information related to a patient pertinent to current patient medical conditions. Information may be suggested through the use of forms specifically tailored to a patient. Specifically tailoring forms for a patient may involve structuring information to present in the forms in a manner allowing for efficient access to the information. A hierarchical information structure allows for this efficient information access by organizing the information based on clinical concepts or conditions for a patient. For example, all information relating to gastrointestinal conditions such as location of pain or existence of abdominal swelling may be stored under a gastrointestinal clinical concept. This information may be accessed at one location of a structured information hierarchy, and not in multiple forms stored throughout a clinical form library. Clinical concepts may have other related clinical concepts under them in the hierarchy, which further allows for a natural progression and flow of information related to clinical concepts as the information hierarchy is accessed by a system.

Adaptive medical information intake may make use of a clinical documentation system using structured clinical data to organize information relating to clinical concepts to be presented to users. The clinical documentation system may be able to merge predefined form sections or templates stored as structured clinical data such that information requests and presentation is not duplicated. Information being provided in real-time by a user and patient information extracted or accessed from previous patient EMRs may be used to determine which templates, or what parts of templates, are to be presented. The end result may be a real-time adaptable form constructed of templates, or template sections, specifically selected from the structured clinical data to suit a particular patient such that the constructed form contains all the relevant information needed to document the medical care of the patient. Adaptive medical information intake may also involve adapting to a user type or role by using qualifiers to provide specific information related to specific roles of users accessing a clinical documentation system. For example, a nurse may be presented with different information than a physician. Physicians, nurses, and patients may be associated with different types of form sections and templates, containing specialized information relating to the role of the user.

A clinical documentation system may be configured to react to user input with suggestions that are sensitive to contexts specific to the patient. For example, causes of shortness of breath in an elderly patient may be provided based on information identified from an EMR for the patient. The contexts involved would indicate that causes of shortness of breath in a child would not apply because of an age identified for the patient. In such a case, the structured information may be accessed at a clinical concept level involving a shortness of breath, and the age of the patient may be used as a qualifier in a sub-hierarchical level of the structured data to customize the information provided for the patient. Similarly, an elderly patient presenting a problem of back pain may cause a clinical documentation system to access clinical concept values located subordinate to the clinical concept of pain and the qualifier of a lower back location, and use those values to prompt a user to ask four selected questions indicated from the structured clinical data and relevant to elderly patients amongst a total of 16-20 risk assessment questions relating to back pain for all possible types of patients.

A clinical documentation system may rely on prior clinical knowledge to support context sensitive suggestions for integrations of sections into a form. The different sources of prior knowledge may include ontologies to describe arbitrary contexts, clinical information and practice settings, clinical guidelines and workflows, prior patient EMRs, or any other source of clinical knowledge that may be useful in determining inferences for form assembly and creation. The use of both general and site-specific prior knowledge and information in a clinical documentation system increases the ability of the system to adapt and customize functionality for different users and different medical facilities.

In an embodiment, a document model, a mapping model, and a domain model may be used. The document model outlines the structure a document may take using structured data. For example, clinical structured data may involve multiple forms, form sections, subsections, elements, or questions may have rules associated with their respective presentation, content, and structure, and a document model may contain and enforce those rules. The domain model may be operable to link terms or concepts with other terms and concepts. The mapping model may be operable to link particular terms and concepts with the document model. For example, a weighted probabilistic network model may indicate links between specific terms and document elements such as form sections. The whole of the weighted probabilistic model may contain all possible connections between terms and form sections. When data is input into the three model system, inferences may be made using the three model system such that iterative analysis of input data may present acceptable levels of probability that proper form sections are included. For example, data including an age and gender may be input. Some connections in probabilistic network may be reduced to zero probability, or dropped, based on the data. In this example, the entry of Male may reduce the probability the patient is pregnant to 0%, and thus no sections relating to pregnancy will be included in a final document or form. As indicated above, as more data is input into the system, the process may work iteratively based on the additional data. In this example, the patient may be requested for an age, and provide information indicating that the patient is 10 years old, which in turn may reduce other probabilities in the model such as the probability the patient has Alzheimer's disease. The combined data may also be used to cumulatively reduce probabilities. In this example, the information indicating the patient is male may reduce the probability of the patient have breast cancer to 20%, and the information indicating the patient is 10 years old may further reduce the probability connection of the patient to breast cancer to 2%. Also, the domain model may analyze the input information to find associated information to provide the probabilistic network model to further update the probability connections. The iterative nature of providing and requesting information may continue until all probabilities are found acceptable, or found to be stable such that the entry of further information may not significantly affect the probabilities of the model. When a model reaches a steady probability state, a final document having form sections related to the remaining probable connections may be produced based on the rules of the document model. In an embodiment, the process may be continually iterative, and update probabilities and/or request further information continually as new information is input. Also, in an embodiment, the document model may be integrated into the domain model, and considered a singular model.

A document model may employ central document control for standardization of clinical concepts and form presentation. This may allow for resulting clinical documents or forms that are readable and consistent in structure to allow quick and easy navigation by system users, yet uniformly interpretable by the system against a single overarching hierarchical structure. The system may receive clinical information in electronic form having hierarchical data interrelationships. The system may provide a meta-model that defines sets of generic concepts, modifiers and relationships that collectively are used to describe the input information allowing a part or parts of a document to be referenced at different levels in structured knowledge expressions. Additionally the overall resulting clinical document structured knowledge model may be analyzed and reasoned over using structured knowledge (e.g., description logic). This enables semantic analysis of a document structure and document content.

A document model may execute a method to process information in a previously existing form structure by finding and combining like data into reusable portions of information called document or form elements. A data structure is composed into the element to retain the element's unique usage within a document. The method creates concept types and relationship types, as defined by a meta-model, for a clinical document model based on a set of rules. The set of rules may involve rules related to presentation of information in forms such that a consistent presentation format is maintained.

As indicated above, existing documents may be broken into parts, and like document parts may be associated with clinical concepts. The creation of a structured knowledge model for use with a document model allows for the identification and use of like form parts as formal entities (e.g., Elements, Features and Values) and associations may then be made to the elements to link them to underlying clinical concepts. An overall hierarchical document outline or model, or a number of large models, may result and provide a uniform navigation structure and a consistent location for different types of document information for use by an adaptive medical information system. A data structure constructed from data extracted from existing forms, along with a document meta-model, may be used to generate a structured knowledge model. The resulting knowledge or document model may be used for analysis (e.g. classification, consistency) and view processing (e.g., merging of user views or forms) in an adaptive medical information system.

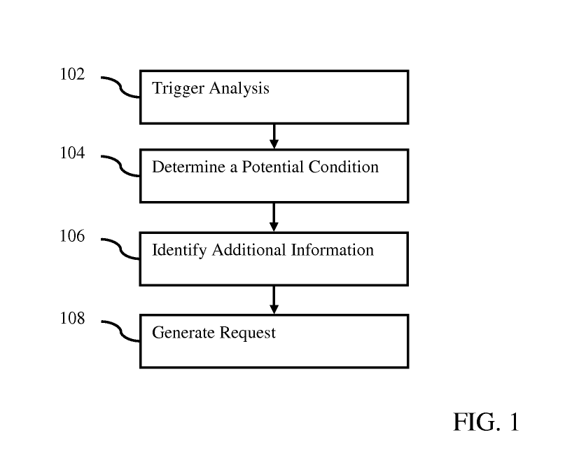

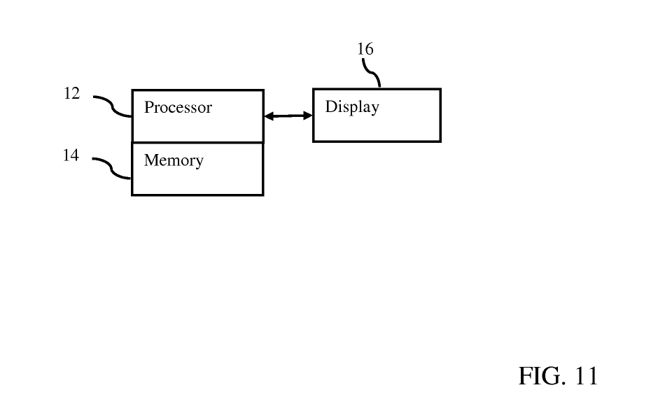

FIG. 1 shows a flow chart diagram of an embodiment of a method for adaptive medical data collection. The method is implemented by a computerized physician order entry (CPOE) system, an automated workflow system, a review station, a workstation, a computer, a picture archiving and communication system (PACS) station, a server, combinations thereof, or other system in a medical facility. For example, the system or computer readable media shown in FIG. 11 implements the method, but other systems may be used.

Additional, different, or fewer acts may be performed. For example, an act for optimizing performance of a task of a workflow is provided. The method is implemented in the order shown or a different order. For example, acts 102, 104, 106, and 108 may be performed in parallel or repeated.

In act 102, an analysis of electronic records is triggered in response to information input into an EMR of a patient. The information may be input into electronic format through any method. In an embodiment, the information may be input into an electronic form of an EMR for a patient. In another embodiment, the information may be freely input into a generic EMR. For example, a user may speak into a microphone indicating a symptom. The patient may input the language “I have a headache” into the microphone where it is electronically transcribed to indicate a symptom. Any automated speech recognition method, such as Hidden Markov Models, Dynamic Time Warping, or Neural Networks, may be used.

The analysis may be triggered by any act. In an embodiment, the analysis is triggered based on recognition of an input of data into an EMR. Recognition of an updated field in an electronic form or database of an EMR of a patient may also trigger the analysis. The analysis may be performed using the information input into the EMR that triggered the analysis.

The electronic records may be any electronic record from which a potential diagnosis or treatment for a patient may be inferred independently, or in combination with other electronic records. For example, electronic records may include ontologies of arbitrary contexts, clinical data records, practice data records, clinical guidelines, EMRs of prior patients of a medical entity.

In act 104, a potential condition for the patient is determined based on the analysis. The analysis may be any analysis of electronic records capable of determining a potential condition for a patient. In an embodiment, the analysis involves the application of a machine learned model to the electronic records. For example, a Bayesian Network model trained using a Markov Chain Monte Carlo (MCMC) method may be used. In another example, an Expectation Maximization method based model may be used. The machine learned model may be trained using knowledge of an expert, or documented prior knowledge such as ontologies or medical databases. The model relates possible inputs as a feature vector for a patient to conditions.

A condition may involve any condition for a patient, and may be a clinical concept. In an embodiment, a determined condition involves a medical condition of the patient. For example, a condition may be heart disease, diabetes, epilepsy, hepatitis B, an allergy, or any condition related to the health or status of a patient. The condition is a possible diagnosis. A given input feature vector may indicate only one or more than one possible diagnoses and corresponding conditions.

In an embodiment, a probability that a patient has a condition is determined. The determined probability may be compared to a probability threshold, and if the probability meets a threshold it is determined that the condition applies to a patient. For example, a probability threshold may be 75% probability that a condition applies to a patient. Any determined probability larger than 75% may indicate that the condition applies to a patient. Any probability scoring system may be used. The machine learnt model may be probabilistic, so outputs a probability associated with one or more conditions.

In an embodiment, a probabilistic network may be used to determine possible conditions for a patient. The probabilistic network may have connections between terms or concepts and associated conditions represented by probabilities indicating that a current patient may have a condition. The probabilities may represent a current state of knowledge or data for a patient, and may be updated with inputs of additional information.

Multiple conditions may be determined to apply to a patient. A given model may provide more than one condition. Alternatively, different models, such as models specific to one or more conditions are applied to the data for the patient. Different models test for different conditions.

In act 106, additional information indicated as relevant to the potential condition of the patient is identified. The additional information may be associated with a condition determined for a patient, and identified upon determining that a condition applies to a patient. The additional information may involve any information relevant to determine a diagnosis for a patient. The additional information may be identified as subordinated information to a clinical concept in a structured information hierarchy. In an embodiment, the information may be determined to provide further indication that a condition applies to a patient. For example, if a patient indicates that they have a headache, other information such as history of headaches or recent physical injuries may be identified as relevant to a potential condition of persistent migraines, or post-concussion syndrome may be determined as potential conditions for a patient. All possible additional information may be stored in a collection, and relevant information may be identified from the collection. Additional information may be indicated as relevant through the application of a model, such as a machine learned graphical probabilistic model, as described herein.

Information may be configured as individual fields in a database associated with conditions, or collections of fields associated with conditions. The information may also be configured as a structured information hierarchy using clinical concepts and subordinated qualifiers and values. When a condition is determined, or a possible condition is identified, fields associated with the condition may be identified. For example, a possible condition may be indicated with a probability of 73%, and all fields associated with the condition may be identified. Contrarily, if a probability of a condition is below a certain probability, such as below 35%, the fields associated with the condition may not be selected.

In an embodiment, additional information may be grouped as related to various conditions in a structured information hierarchy. For example, fields or elements for the additional information may be assembled or contained in preformatted form templates based on the location of the fields or elements within the structured information hierarchy. The form templates may each be associated with at least one condition. Once a condition is indicated, an associated form template may be identified. Multiple form templates may also be identified.

In an embodiment, additional information may be identified as individual fields for the additional information, wherein the individual fields are associated with a condition. All fields determined to be associated with a condition above a certain probability may be identified.

In act 108, a request for the identified additional information is generated. The request may involve selecting an established collection of information associated with the determined potential condition of the patient. The request may be generated as a presentation of a manually created form, or as an automatically created or generated form.

The request may be generated by the use of a document model. A document model may involve structured knowledge of a clinical area. In an embodiment, clinical data documents, or clinical forms, may be centrally managed by transforming clinical document text of a plurality of different clinical documents and/or document types into structured clinical knowledge or data. Hierarchically organized clinical document text of a plurality of existing different clinical document types may be received. A repository of information including clinical concepts and rules determining relationships between clinical concepts comprising text elements, text element qualifiers, and text element values may also be received or otherwise available. The text of the received documents may be analyzed to identify clinical concepts in the received documents, generate an inventory of identified concepts, combine clinical concepts to provide concept combinations, and generate the information structure using the inventory and the concept combinations. The document model may then use such a developed information structure to generate a request for the identified additional information. For example, the identified information may be located in the structured information as a text element associated with a clinical concept, a text element qualifier, or a text element value. The identified text element, text element qualifier, or a text element value may be presented to a user formatted according to rules of the document model for presentation and hierarchical placement within a form for a specific patient.

In an embodiment, the established collection of information is a preformatted medical form or form section. The form is electronic and may be a collection of fields associated with an EMR of a patient. The fields may be used to record and store the information associated with a condition. The fields may be clear of data, and configured for inputting information into an EMR, or other database. In an embodiment, the fields may have standardized information contained in them relating to a condition. For example, the standardized information may indicate that a certain dosage of acetaminophen is a typical treatment for a patient with a headache condition.

In an embodiment, some of the fields or values may be pre-populated with information for the patient pulled or mined from other portions of the EMR. For example, an age of the patient may be determined from other areas or individual records of an EMR, and the age may be pre-populated in the form. In another embodiment, the fields having information mined from an EMR will be withheld from presentation with the form. The information, however, may still be noted and associated with the condition for the patient. For example, a form may not indicate an age for a patient, but an age is determined, and a dosage for a medication may be determined based on the condition and the mined age of the patient. Any data mining may be used, such as is disclosed in U.S. Pat. No. 7,617,078, the disclosure of which is incorporated herein by reference.

In an embodiment, a collection of form templates or sections may be stored, each associated with a particular condition and containing fields for information relating to the condition. Form templates relating to conditions determined for a patient may be selected and presented on a display as part of generating a request for identified information relating to the conditions. The form templates may be presented in a pre-formatted whole, containing fields for all identified information relating to a condition. The form templates may also be presented in part, displaying only fields relating to information identified as most critical to diagnosis or treatment of the condition. The form templates may also be constructed with the use of a structured information hierarchy that indicates fields to be used in a form template based on identified clinical concepts of a patient.

Multiple form templates for different conditions or clinical concepts may be displayed at once as a singular form, or separately. If different forms include requests for the same information, the forms may be merged to provide one request rather than duplicative entry. The merging may be performed using an information structure hierarchy to indicate similar clinical concepts.

In an embodiment, condition determination may be iterative. A portion of the identified additional information may be received. Other information regarding the potential condition of the patient may be identified based on the received identified additional information. The analysis may be re-performed using the other information to identify further information relevant to the potential condition of the patient, and a second request for the further information may be generated. Numerous inputs of information and requests may be generated during an iterative process of adaptive medical information input to determine a diagnosis or treatment of a condition.

In an embodiment involving machine learned models, the performing and re-performing an analysis may be undertaken by applying a first machine learned model and the identifying other information may involve the application of a second machine learned model. The second machine learned model may receive the identified additional information and generate the other information. The other information may be additional terms or medical characteristics that may be added to the analysis of the first machine learned model to provide higher accuracy for determining information, or forms, pertinent to the patient. As such, there may exist a form hierarchy wherein a general condition, such as head pain, has a general form template designed to gather further information to further diagnose and narrow the head pain condition. For example, the request for information may involve a query for information to determine if a patient has a concussion, or if the patient suffers from chronic migraines, each of which may have respective forms in the hierarchy, with fields for specific information relating to each condition. The second machine learned model may be designed to take the input from the initial request, and combine the information with other information to further output a potential diagnosis for a condition that may be input into the first model to identify further forms.

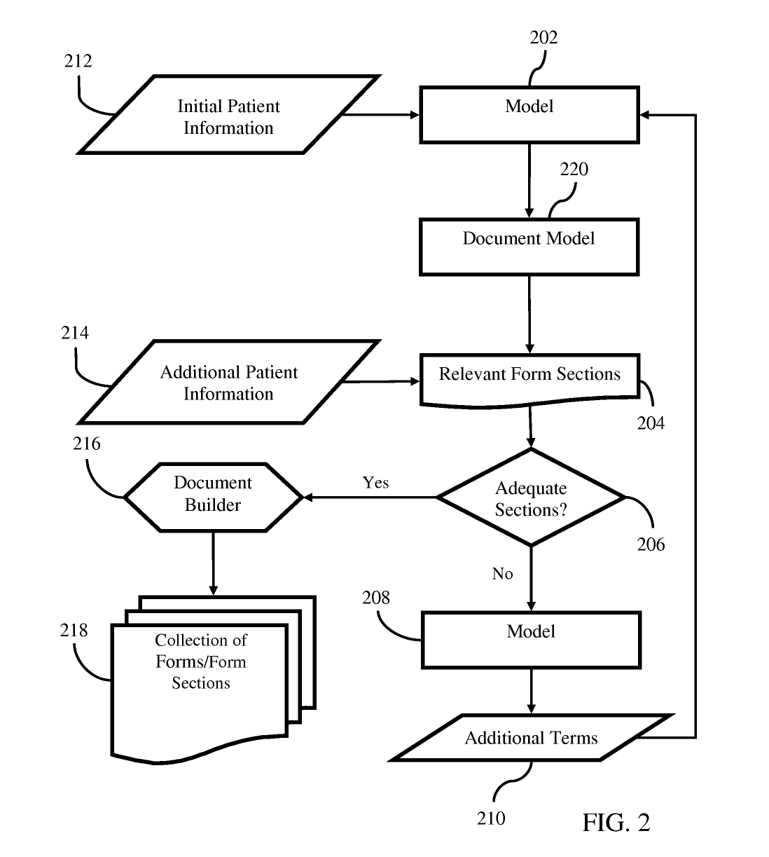

FIG. 2 shows a flow chart diagram of an embodiment of adaptive medical data collection. The diagram may describe the operation of a system, such as that described with respect to FIG. 11 described below, or another structure operably consistent with the diagramed components. Additional, different, or fewer components may be used.

An analysis of electronic records using a model 202 may be triggered in response to information 212 input into an EMR of a patient. The model 202 may determine a potential condition for the patient based on the analysis. The model 202 may identify information in an information structure of a document model 220 based on the potential condition for the patient. The document model 220 may provide the information in form sections 204. The model 202 may identify additional information contained in form sections 204 indicated as relevant to the potential condition of the patient. A request for the identified additional information may be generated by selecting a medical form or form section 204 using the document model 220. The form or form section 204 may be determined relevant and selected based on a probability a patient has a condition associated with the form determined by the model 202 and the document model 220. Form sections 204 may be entire forms, or sections of forms designated for certain conditions. Form sections may be constructed using a structured information hierarchy contained in the document model 220 based on probable conditions of a patient and corresponding clinical concepts stored in the structured information hierarchy. Views of the relevant form sections 204 may be displayed for data presentation or data input. In an embodiment, the model 202 and the document model 220 may be integrated into a singular model.

Adaptive medical data collection may be iterative. An iterative embodiment may involve receiving at least a portion of the identified information. For example, additional patient information 214 may be input into some, or all, of the fields of relevant form sections 204. Using a second model 208, other information or additional terms 210 may be identified or determined regarding a potential condition of a patient based on the received identified information. The analysis may be re-performed by a first model 202 using the additional terms 210 to identify further relevant form sections 204 using the document model 220.

Iterations may continue until is determined in act 206 that there is enough, or adequate, requested or presented information, or whether there have been adequate form sections identified, generated, and/or presented. The determination may be made based on predefined criteria. In an embodiment, a minimum number of form sections may be required. In an embodiment, an adequate section determination 206 may be made based on probabilities of a condition for a patient. For example, form templates associated with conditions determined beyond a threshold may be provided. Further, conditions within a range of probabilities may require iterations to better establish a likelihood the patient has the condition. The model 208 may refine the information contained by providing additional terms to use with the model 202 to select further relevant form sections 204 using the document model 220. For example, iterations may be provided for conditions determined with a probability of 45% to 75%, where 75% may be the probability threshold. Iterations may continue until all probabilities determined for all conditions are either below 45%, or above 75%.

In an embodiment, when it is determined that there are adequate form sections, a document builder 216 may be used to create a total collection of forms/form sections for generation or presentation. The document builder 216 may include rules for the format and presentation of forms. The document builder 216 may be part of the document model 220. The document builder 216 may also be included in a non-iterative embodiment, after relevant form sections 204 have been determined by the model 202 using the document model 220. The collection of form sections 218 may be presented in an order according to a set of ordering or ranking rules. In an embodiment, form sections may be ranked by probability of a patient having the condition associated with the form section, with the highest probabilities being placed most prominently in a collection of form sections 218. Examples of prominent placements of form sections 204 may include being placed at the top of a collection 218, displayed with highlighted or more noticeable text than other form sections of the collection 218, or a form section may require input prior to inputs of other sections.

In an embodiment, the models 202 and 208 may be one unified model. In an embodiment, the models may be machine learning models. The models 202 and 208 may be trained based on a collection of prior medical knowledge to represent and efficiently manipulate a probability distribution of conditions for a patient associated with document sections 206. Document sections 204 associated with a condition determined to a certain probability to apply to a patient may be included in a personalized main document 218. The main document 218 may group relevant subsections 204 that contain information needed to be registered for a given patient in a given clinical visit. The relevant subsections 204 included in a main document 218 are associated with conditions having a probability of relating to a patient. The probability of relating to a patient may be modeled using the machine learned model 202, which may be a generative probabilistic model such as a Bayesian Network model. The generative probabilistic model may represent relationships among medical concepts or terms and document sections such as term-term relations, sections-term relations, sections-terms relations, and section-section relations.

Probabilistic graphical models are graph-based representations for encoding a distribution over multi-dimensional space, wherein each node in a graph represents a random variable. Links between nodes specify a direction or relevance of an association. The edges of the graph each have an associated real number usually referred to as an exponential family weight. A positive link weight between two nodes means that an increase or decrease in the value of node 1 causes an increase or decrease, respectively, in a value for linked node 2. A negative link weight indicates a decrease value for node 1 increases the value for node 2 or vise versa. The absolute value of the weights is a measure of strength of influence by any parent node on a child, or linked, node. A node in a graphical model may encode either discrete or continuous probability distributions.

Graphical models for adaptive medical information input may be trained in two steps. The first step involves learning or designing the structure of the network. The first step may be performed by an expert in the knowledge of the medical area and form constructs being graphed, by a prior form knowledge structure, or automatically through a learning algorithm such as a Markov Chain Monte Carlo (MCMC) local search method. For example, an expert may recognize that a particular form may be associated with a particular condition. An expert may also recognize that the information in one form is related to information in another form. These associations may be recorded and integrated to form the structure of the network. The first step may also involve a hybrid creation which may consist of applying an automatic algorithm first and later modifying the resulting network using known relations, an expert, or prior knowledge.

A second step in training a graphical model for adaptive medical information input may involve learning the parameters of a network including unrealized relationships between conditions and forms, or strength of associations between forms and conditions. In an embodiment, an Expectation Maximization search algorithm may be used. Such an embodiment may alternate between solving two problems, an expectation and a maximization, to compute maximum likelihood estimates of parameters for the model. The algorithm may start with random initializations of model parameters, and converge onto optimal point estimates, resulting in a network of nodes relating to conditions and associated form sections.

Once a model is trained, a set of evidences may indicate a probability that a given section should be included in a current personalized collection of forms 218. The evidences may include information such as patient characteristics, complaints, or sections already included in a document. Probabilities may be determined by a model using any method. In an embodiment, a Junction Tree algorithm is used.

A document model 220 may use structured knowledge representations of clinical document content. The structured knowledge allows for classification and consistency checking of a document with relation to the document's content. The document model 220 may be used for any electronic document where one or more parts of the document are relevant at a time. The system may not use explicit declarations of what is a concept or relationship, but may use a set of heuristics (i.e., rules) to determine what is a section, concept, a feature (relationship), or a value of a value set and maps this structured information to clinical concepts or conditions of a patient.

In one embodiment, the document model 220 uses a document processor to translate information outlines into structured document models, merges document model information and views, and generates new information output structures. A meta-model may define concepts and properties used for construction of documents into a normative form. An interface receives hierarchically structured information. An outline-to-model or document processor may create structured data models by, representing the information outline in terms of instances of concepts and/or properties as defined by the meta-model based on a heuristic method by combining like information items into reusable concepts, connecting created concepts via properties to retain original structure, and using like concepts in different contexts. The document processor may differentiate like element concepts via addition of a context path prefix. A merge processor may merge document views using element set unions and carry forward previous document information into a new set of elements. An elements-to-document processor may create structured output data from a set of elements, an information hierarchy, and a map of the element to the hierarchy. A meta-model may include a generic concepts element, feature, element set and value and a set of generic relationships (i.e., properties) used in logic expressions allowing for concept qualification to maintain document structure (unique contexts).

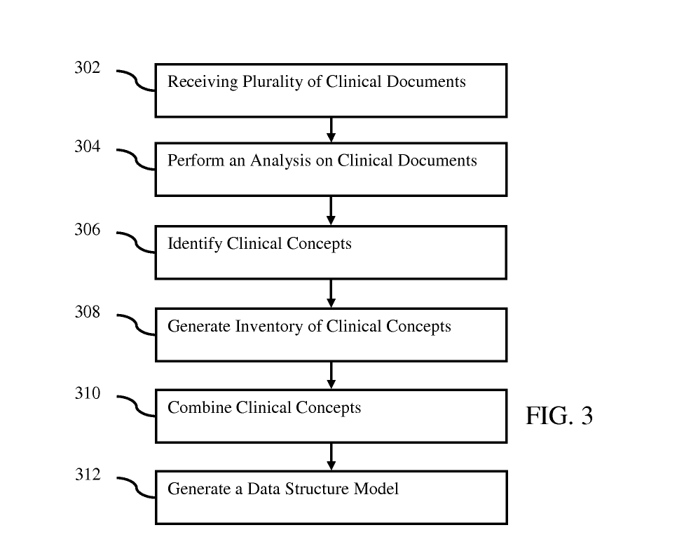

FIG. 3 shows a flow chart diagram of an embodiment of a method for managing clinical data documents involving the generation of a data structure from existing clinical documents or forms. The method is implemented by a computerized physician order entry (CPOE) system, an automated workflow system, a review station, a workstation, a computer, a picture archiving and communication system (PACS) station, a server, combinations thereof, or other system in a medical facility. For example, the system or computer readable media shown in FIG. 11 implements the method, but other systems may be used. Additional, different, or fewer acts may be performed. In an embodiment, the data structure is generated and integrated into an adaptive medical information system to manage the clinical data documents, or forms, of the system.

In act 302, hierarchically organized clinical document text of a plurality of different clinical documents is received. The hierarchically organized clinical document text includes text elements, text element qualifiers, and text element values. In an embodiment, the clinical document text may involve electronic forms existing in an electronic record system. The clinical documents may be forms, and a form may be considered a collection of text elements, text element qualifiers, or text element values. In an embodiment, the received clinical document text may involve clinical questions and answers. For example, clinical document text may involve the entirety of a manually constructed form for use in the diagnosis of gastrointestinal uses. Multiple questions, such as existence of abdominal pain or existence of abdominal swelling may be presented. The questions in this example may be considered text elements, and the context of the text elements may indicate a clinical concept, such as gastrointestinal symptoms. Text element qualifiers such as amount of pain, or specific abdominal location of pain, may also exist in the form, and be recognized as such. Values associated with the text element and text element qualifiers may be answers to the questions, and as such be considered text element values. For example, a gastrointestinal symptom clinical concept having an abdominal pain text element, which in turn has a text element qualifier of location, may have associated text element values of epigastric pain, perinumblical pain, diffuse, or multifocal.

In act 304, an analysis of the text elements, the text element qualifiers and the text element values of the received clinical documents is performed. The text element qualifiers and the text element values may be analyzed using any method. In an embodiment, an analysis may involve applying a medical ontology to at least one of the text elements, the text element qualifiers and/or the text element values. The medical ontology may determine categories or similar subjects for the text elements, the text element qualifiers and/or the text element values of different documents.

In an embodiment, through an analysis, meaning may be associated with parts of a received electronic medical document, and clear boundaries between different parts of a document are determined and like parts are identified. Parts of a document may include text elements, text element qualifiers, and/or text element values. For example, text elements such as abdominal pain and nausea may be associated with a meaning indicating that they are gastrointestinal symptoms, which may be separated from other parts of the form which indicate a different clinical concept.

The text elements, text element qualifiers, and text element values may be already designated in a plurality of received clinical documents. The already designated text elements, text element qualifiers, and text element values may, however, have redundant elements, and not exist in an efficient format indicating an effective hierarchical data structure for managing documents.

The text elements, text element qualifiers, and text element values of the clinical documents may not be designated as such when received. In such an embodiment, a document meta-model or information repository may be referenced to detect or determine the text elements, text element qualifiers, and/or text element values of the received documents. Text elements in a clinical setting may involve vital signs such as blood pressure, heart rate, SPO2 blood oxygen saturation, temperature, and/or electrocardiogram (ECG) data. The text elements, text element qualifiers, and text element values may be determined through the structure of existing documents or forms. For example, the placement of text on a form may indicate an associated level of a hierarchy. A question may be presented with four pre-provided possible answers in a readily recognizable standard question answer format for a form. The question may be considered a text element, and the pre-provided answers may be determined as values. Further, text element qualifiers may be extracted from forms as well. For example, a title of a form or form section involving back pain may indicate that the term “back” is a qualifier of a “pain” text element. Part of speech detection and medical ontologies may be used along with text recognition systems to detect elements from existing forms or documents, and to associate meaning with these elements.

In act 306, clinical concepts in the received documents are identified based on the analysis. Clinical concepts may be identified by any method. In an embodiment, the text elements, the text element qualifiers, and/or the text element values may be assigned to a clinical concept of a pre-prepared list of clinical concepts. For example, a text element indicating appetite loss may be assigned a clinical concept of gastrointestinal symptoms. In an embodiment, the clinical concepts may be identified based on categories or similar subjects determined from the application of a medical ontology as part of the analysis performed in act 304. In an embodiment involving an information repository, clinical concepts may be identified by matching clinical concepts from the repository of information to clinical concepts determined from the received documents. In an embodiment, parts of an analyzed document are associated with clinical concepts, and text elements, text element qualifiers, and/or text element values of that document part may be associated with the same clinical concept. For example, a text element indicating pain, along with a text element qualifier such as location (e.g., abdominal) and text element values such as epigastric or periumblical may be associated with a clinical concept of gastrointestinal symptoms.

In an embodiment, identifying clinical concepts may involve comparing the text elements, the text element qualifiers and/or the text element values of different documents of the plurality of different clinical documents. For example, similar text elements, text element qualifiers or text element values may be assigned a common clinical concept. Ontologies may be used for such a comparison to determine clinical concepts. For example, an ontology may indicate that the text of a text element, text element qualifier, or text element value indicate a clinical concept.

In act 308, an inventory of identified concepts is generated. The inventory may be generated as a list of all identified concepts from the plurality of documents. In an embodiment, an inventory of identified concepts may be generated by identifying replicated concepts and generating a map linking individual identified concepts to corresponding concepts in a received hierarchically organized clinical document.

In act 310, clinical concepts are combined to provide concept combinations. The clinical concepts may be combined using any method. In an embodiment, combining clinical concepts involves grouping the inventory of identified concepts based on categories determined from a medical ontology. In an embodiment, text elements, text element qualifiers, and text element values already are ordered and combined based on identified clinical concepts into a hierarchical data structure.

In an embodiment, combining may involve combining identified concepts in the inventory of identified concepts where determined path lengths of text elements, text element qualifiers, or text element values are similar. The similarity may be determined using any method. For example, a number of hierarchical levels between a text element and a text element value may be determined, and a measure of similarity may involve the total number of hierarchical levels that are the same. In another example, text element values may be compared directly for similarity based on text comparison techniques. In an embodiment, concepts may be combined where a similarity is determined to be beyond a predetermined threshold of similarity. In an embodiment, concepts may be combined to provide concept combinations by matching text elements having the same text element qualifiers and/or text element qualifiers having the same text element values.

In an embodiment, text element path lengths may be determined and compared to determine similarity. A path length may be a count of hierarchical levels between a text element and text element values, or a path length may involve a count of the number of text element qualifiers for a text element. Path lengths for text elements may be compared and similar path lengths may be combined as a clinical concept. For example, concepts may be combined where a determined path length is equal for text elements. The specific text for text element qualifiers and text element values may also be compared, and text elements having similar specific text element qualifiers or text element values may be combined as clinical concepts. In an embodiment, the text element qualifiers for a text element may be compared for similarity, and text elements may be considered similar if there are matching text element qualifiers.

In an embodiment, combining clinical concepts may further involve grouping text element qualifiers from different documents of the plurality of different clinical documents under a same text element based on categories determined for the identified clinical concepts.

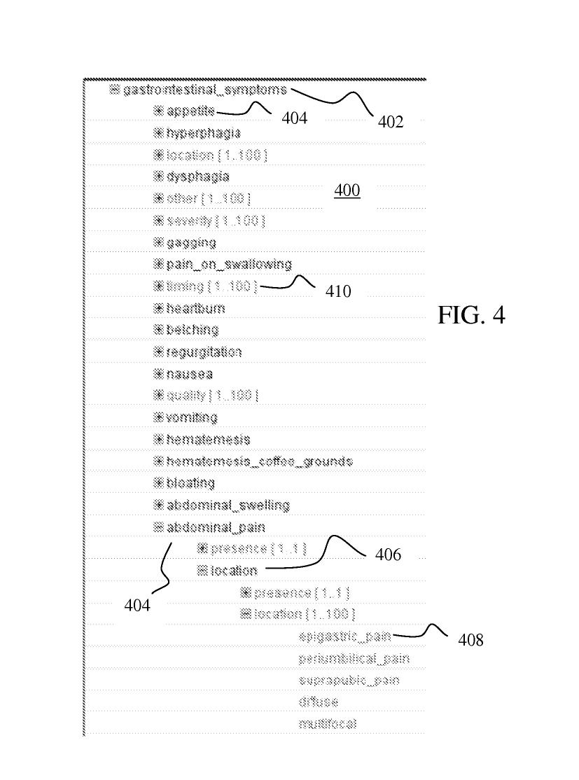

In act 312, a data structure model using the inventory and the concept combinations is generated. The data structure model may involve a hierarchical information structure. The data may be structured such that there are text elements for clinical concepts and text elements subordinated under the clinical concepts in a hierarchical structure. Text elements may have associated text element qualifiers, and text element qualifiers may have associated text element values. The document structure model may be any appropriate structured form. For example, a gastrointestinal symptom clinical concept having an abdominal pain text element, which in turn has a text element qualifier of location, may have associated text element values of epigastric pain, perinumblical pain, diffuse, or multifocal as identified from a clinical form, or multiple clinical forms, may be constructed into structured hierarchical information as shown in FIG. 4. A document model structure may be generated as a logical expression string of concepts and logical operators representing said information structure. Such a representation may be considered, or resemble, an outline in form. The data structure model may involve a centralized repository of normalized clinical concepts and rules, and may be used as a document model or with a document model. The data structure model may also be operable to generate a map linking an individual text element to a location in the hierarchical data structure of a document model.

In an embodiment, an information structure may be generated by merging concepts of a previously generated information structure and concepts identified from received hierarchically organized clinical documents by performing a logical union of text elements. For example, identified concepts may be merged into similar concepts of the previously generated information structure.

In an embodiment, rules may be provided in a document model for the generation of a data or information structure. For example, the rules may involve linking text element qualifiers to text elements, linking a text element value to a text element qualifier, linking a set of allowable values to a text element qualifier, and linking a parent text element to a child text element. These rules may be contained or stored in a document meta-model or information repository of a document model.

In an embodiment, a data structure model may also involve differentiating concepts of concept combinations by a hierarchical path in a received hierarchically organized clinical document. The differentiating concepts may involve the addition of a prefix to similar text elements.

In an embodiment, a method may also involve classifying the identified concepts into categories having similar properties, and performing consistency checking on values of similar text elements and text element qualifiers. The classifying may be performed using a clinical ontology and the consistency checking may involve matching the values for similar text elements. If the values are not found to be sufficiently matching, the generated data structure model is deemed not consistent.

Centrally managed clinical data documents may also involve managing and/or creating views of documents or forms. A document model may create a view of clinical information given the many combinations of multiple current and past medical conditions along with variations accounting for different age groups, gender, genetics and environments causes. The document model may accomplish this by using a small number of overarching views (i.e. one for each application such as an emergency room, or a pediatric practitioner's office) and enables creation of a smaller number of smaller subset views that are readily combined together manually or algorithmically (via computer software) to form more complex views (i.e., individual usage documents, context aware dynamic views). Multiple clinical concepts may need to be viewed at the same time. This will require merging of multiple views of forms for clinical concepts or text elements into one coherent view of all required forms or other collections of text elements, text element qualifiers, or text element values. The document model may provide data indicating a union of sets of elements from a document knowledge model that are related back to an overarching hierarchy to provide a coherent output format for clinical documents or forms. This data may be used as format rules in a document model. The output format may be formats matching or extracted from, the received clinical documents. The output format may involve rules relating to allowable locations of clinical concepts, text elements, text element qualifiers, and text element values in a form.

A document model may also provide the same type of information in unique document contexts (e.g., presence of Diabetes in the Patient History section versus presence of Diabetes in the Family History section, Work Address and. Home address). The document model enables reuse of like document parts, forms, or sub-forms, that are also qualified by a context in which parts are used in the document. A system may enable the creation of one or a small set of simple centrally managed hierarchies that may each have different data views derived from it by creating elements sets for different clinical situations. Multiple views are readily merged since they comprise sets of elements rather than each being a set of hierarchy paths that may not overlap and hence cannot be merged.

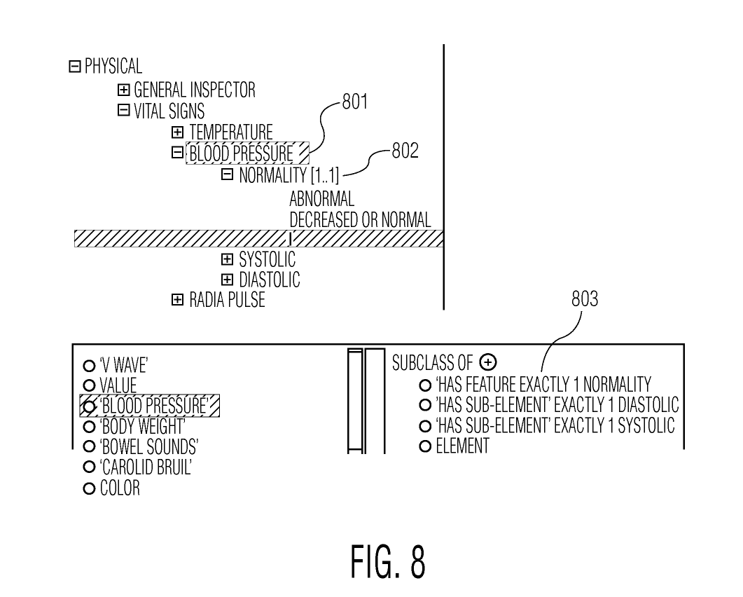

A hierarchical data structure may be constructed in different structures for a structured knowledge model. In an embodiment, an outline structure may be translated into a set of rules relating to clinical concepts in the outline structure and the relationship of these clinical concepts to subordinated clinical concepts, text elements, text element qualifiers, and text element values. For example, FIG. 8 shows an embodiment involving a clinical concept 801 having a subordinated text element qualifier 802 displayed in an outline format, as well as translated into a structure involving logic expressions 803 to be used as rules in a structured knowledge model.

FIG. 4 shows an example of a structured information hierarchy 400 for use in a document model. The structured information hierarchy 400 involves a listing of nodes 402, 404, 406, 408, 410. The nodes may be clinical concepts 402. The clinical concepts 402 may be a text element, and the clinical concept may have text elements 404 subordinated below the clinical concept in a hierarchical structure. The text elements 404 may have subordinated text element qualifiers 406 and text element values 408.

In an embodiment, medical information is shown in an information structure 400 with relationships depicted in an outline format that represents an overall input or output organization of data. Cardinality or hierarchical order of placement among similar elements of a hierarchical tier may be specified on nodes identifying them as features or qualifiers. An example of medical information may be clinical questions and lists of possible answers. The hierarchy may be represented in different ways including as an acyclic graph. For example, XML may be used to display text inter-dispersed with newlines and tabs as are seen in FIG. 4. An information structure may be further defined by the concepts and properties of a domain required for a model based on the information structure 400. For example, the cardinality for a pain clinical concept as used in an operating room may be different than the cardinality used in a cancer treatment ward.

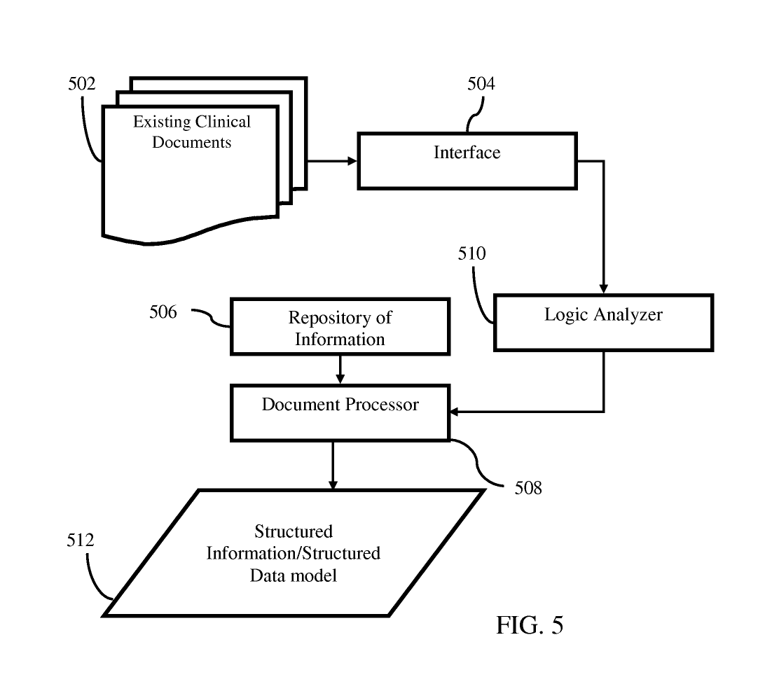

FIG. 5 shows a system for centrally managing clinical data documents. The system may be implemented using any appropriate structural components, such as those disclosed with respect to FIG. 11.

The system involves an interface 502 for receiving hierarchically organized clinical document text of a plurality of different clinical document types 502. The system may also involve a repository of information 506 including clinical concepts and rules determining relationships between clinical concepts comprising text elements, text element qualifiers, and text element values. The system may also involve a document processor 508 configured to use said information for analyzing text of the received documents to identify clinical concepts in the received documents, generate an inventory of identified concepts, combine clinical concepts to provide concept combinations, and generate an information structure 512 using the inventory and the concept combinations. In an embodiment, the information structure may be a structured data model, or part of a structured data model. In an embodiment, the system may also involve a logic processor configured to analyze a received hierarchically organized clinical document structure 502 by classifying said identified concepts into categories having similar properties and performing consistency checking on values of similar elements and element qualifiers. A logic processor may be a type of meta-model.

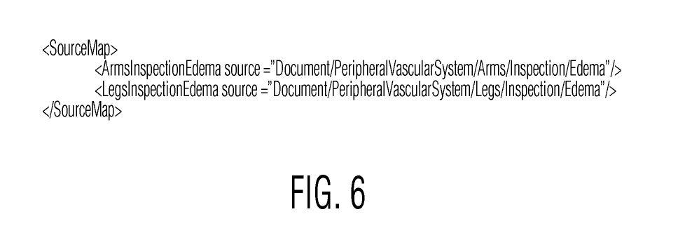

The document processor 508 may provide links to clinical concepts or conditions identified in an adaptive medical information system to the structured information using a source link map as shown in FIG. 6. In an embodiment, the logic analyzer 510 may highlight duplications or near duplications of text elements, text element qualifiers, or text element values using a source link map.

In an embodiment the document processor 508 uses rules executed by a domain specific processor that are defined outside of the repository of information 506, such as form presentation format rules of a document model.

The repository of information 506 may be a meta-model that defines a small set of generic concepts, properties, and/or relationships that may be used to build structured knowledge models 512 of a group of existing clinical documents.

Generic concepts may involve elements as a basic unit of documentation knowledge or information that may stand alone as a clinical concept. Most elements in the documentation space will have a corresponding entity in a clinical domain space (e.g., blood pressure). Generic concepts may involve features or qualifiers which are a qualifying concept of an element. Since a feature modifies or qualifies an element it cannot exist on its own but always exists along with an element (e.g., location, severity, timing, quality). Generic concepts may involve values which may be an answer if a feature is viewed as a question (e.g., epigastric pain). Generic concepts may involve an element list which is a set of elements or values that constitutes a list of allowable answers for a feature in a given context. The element list may be a path in a document or information structure 512.

Generic properties may involve relationships or status indicators of elements. For example, generic properties may include a “hasFeature” property which links features to elements, a “hasValue” property which links values to a feature, a “hasElementList” property which links allowable values to a feature, or a “hasSubElement” which links elements to child elements.

In an embodiment, for uniformity the system requires a strict Element-Feature-Element (values are a type of Element) structure. Sections contain elements which have features that select value sets that may be either specification of quantities or sets of elements that may be further described by features. Elements may be compound and contain other elements, e.g. Blood pressure, contains both systolic and diastolic blood pressure.

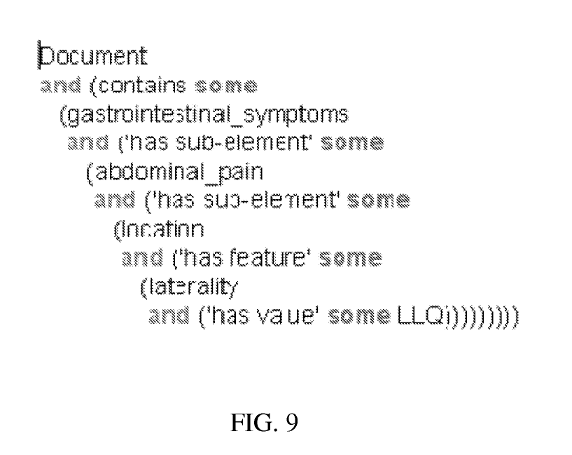

A structured data model 512 may involve certain capabilities. The structured data model 512 may allow for a representation of the content of the input hierarchy in terms of instances of concepts and properties defined in the repository of information 506. The structured data model 512 may allow nodes and groups of nodes to be represented as concepts (Elements, Features and Value Elements). For example, the clinical concept of blood pressure as represented in a hierarchy and in a structured knowledge model 512 is shown in FIG. 8. Logic expressions may be generated from the hierarchy shown in FIG. 8 as subclass property axioms, also shown in FIG. 8. Clinical concepts may be used in structured knowledge expressions as shown in FIG. 9. Specifically, FIG. 9 shows an example expression that references abdominal pain in the left lower quadrant of a presented document. These expressions allow use of logical operators such as conjunctions, disjunctions, and/or cardinality for the presentation of clinical concepts in documents. FIG. 9 shows the usage of conjunctions using via an “and” operator. In an embodiment, the expressions may be description logic axioms. In an embodiment, the structured data model may be represented as an ontology.

The document processor 508 may transform hierarchical representations of medical information, such as that found in existing clinical documents 502, into a structured data model 512 using any technique. In an embodiment, the existing clinical documents 502 are decomposed into parts and translated into concepts and properties as defined by the repository of information 506. The properties and clinical concepts may involve elements, features, values, and/or value sets. Clinical Concept type selection may be performed with the following heuristics:
If a node has a cardinality defined it is a Feature
If a node has a feature child it is an Element
If a node only consists of elements it is a Section
Leaf node children of a Feature are a Value
Multiple children of a Feature form a Value set
Values of Features that have children are Elements
Occasionally a Feature may need to be created that did not exist in the source hierarchy in order to maintain t a strict Element-Feature-Value paradigm

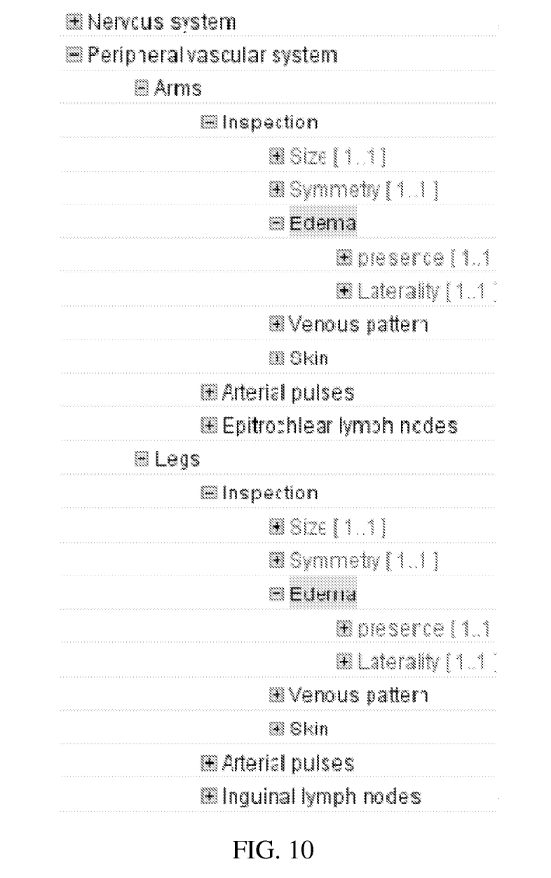

The document processor 508 may also combine like items by merging and reusing common elements, features, values, and/or value sets. For example, documents with questions having the same allowable answers in input hierarchy may be combined, or elements with same features, or features with the same values. An example of common elements may be seen in FIG. 10 with respect to “Edema.” FIG. 10 also shows the highlighting of repeated or common elements of an existing structure. Common elements may be made unique by adding data identifying a context in which the common elements exist. In an embodiment, common elements may be made unique by following a parent path adding the parent as a prefix to the element's name until the element is unique from other concepts. For example, with reference to FIG. 10, the common edema elements may be made unique by adding prefixes and creating elements called “ArmInspectionEdema” and “LegInspectionEdema.” The structured data model 512 may involve a description logic model. A description logic model may be represented as an ontology. For example, FIG. 8 shows Web Ontology Language (“OWL”) Description Logic axioms represented in Manchester OWL syntax.

A document processor 508 may perform an analysis of a hierarchical structure determined from the existing clinical documents 502. The document processor 508 may perform queries based on classifications of concept properties. For example, the document processor 508 may find concepts that contain abnormal/normal question elements. The document processor 508 may also identify potential inconsistencies. For example, the document processor 508 may identify that a same element or feature of an element, such as a question, may be indicated with different allowable values, or answers. To solve such an issue, the document processor 508 may merge slightly different lists into one list, or the document processor 508 may replace close matches with the clinical concept almost matched. The document processor may use a source map as shown in FIG. 6 to go back to a source hierarchy to make such changes to the structured information 512 organization.

A document model may use structured knowledge expressions of a structured data model 512 to create a document or a view of a document. A structured data model 512 may reference single nodes (e.g., a value) or entire branches of the structured information of the structured data model 512. Structured data model 512 references may be combined with references to external entities such as other medical knowledge bases in structured knowledge expressions.

An embodiment may involve a merge processor configured to output document elements to a processor to cause the display of a document. The merge processor may also be configured to merge processor configured to extract elements from document that contain any input or received data. For example, input data may include answers to questions in a provided, or previously provided, document. The merge processor may also merge relevant views by performing logical union of sets of elements. The merge processor may also carry forward any answers into further merged elements of a generated document.

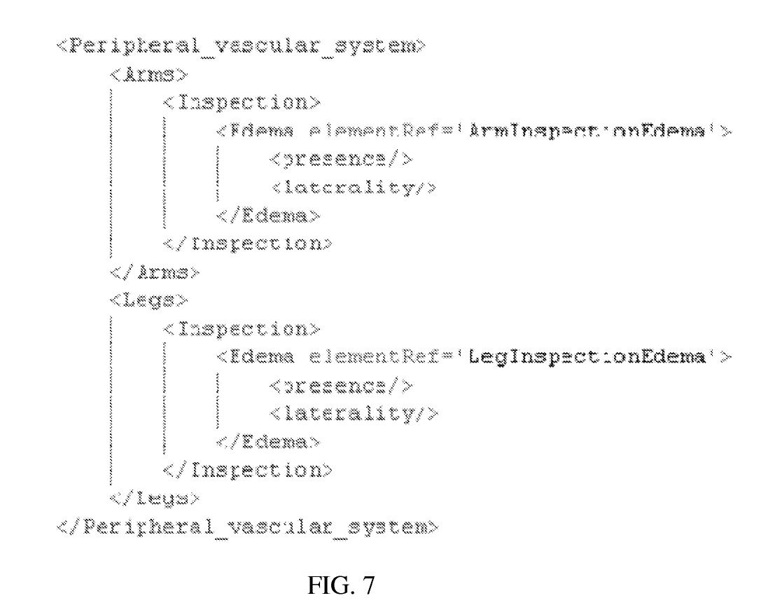

A document model may also involve an element-to-document processor. An element-to-document processor may be configured to take a list of clinical document elements (with or without patient results data values) from multiple views and output an electronic document that is a structured view based on a structure and sequence defined in an original source hierarchy determined from the existing clinical documents 502. The element to document processor may place element references into document, as shown in FIG. 7. The element to document processor may also use a source link map as shown in FIG. 6 to map elements back to their position in the original source hierarchy determined from the existing clinical documents 502.

In an embodiment, a document model may create clinical document views as sets of elements from the structured data model 512. Electronic clinical documents with element references from one or more views may be created, an example of which may be seen in FIG. 7 for a clinical document created using an XML formatting or markup language. Views may involve merging provided documents with data that has been added by a user. In an embodiment, a new electronic clinical document is created by merging additional views together with an original document and the data values in the original document. Such an embodiment may be used with the iterative adaptive data input described with respect to FIG. 2.

FIG. 11 shows a system for managing clinical data documents in for an adaptive electronic documentation system. The system is a server, network, workstation, computer, database, or combinations thereof. The system 10 includes a processor 12, a memory 14, and a display 16. Additional, different, or fewer components may be provided. For example, the system includes a scanner, a network connection, a wireless transceiver or other device for receiving patient information, existing clinical documents and/or communicating patient information to other systems.

The memory 14 is a buffer, cache, RAM, removable media, hard drive, magnetic, optical, database, or other now known or later developed memory. The memory 14 is a single device or group of two or more devices. The memory 14 is shown within the system, but may be outside or remote from other components of the system, such as a database or PACS memory.

The memory 14 stores EMRs for patients and other medical data relating to conditions of patients of a medical facility. Models, such as probabilistic graphical models trained using medical data may also be stored on the memory 14. Multiple EMRs of other patients may also be stored on the memory 14. In an embodiment, the memory 14 is operable to store a plurality of electronic medical records of a plurality of patients of a medical entity, specific electronic medical record of a patient as well as ontologies, electronic clinical information, practice settings, machine logs, clinical guidelines, and workflows. The memory 14 may also be operable to store hierarchically organized clinical document text of a plurality of different clinical documents comprised of text elements, text element qualifiers and text element values, and a data structure model. The memory 14 may also be operable to store a document model

The memory 14 is additionally or alternatively a non-transitory computer readable storage medium with processing instructions. The memory 14 stores data representing instructions executable by the programmed processor 12 for adaptive medical information input. The instructions for implementing the processes, methods and/or techniques discussed herein are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU, or system.

The processor 12 is a server, general processor, digital signal processor, graphics processing unit, application specific integrated circuit, field programmable gate array, digital circuit, analog circuit, combinations thereof, or other now known or later developed device for medical category determination. The processor 12 is a single device, a plurality of devices, or a network. For more than one device, parallel or sequential division of processing may be used. Different devices making up the processor 12 may perform different functions, such as a handwriting detector by one device and a separate device for communicating or processing the detected handwritten data. In one embodiment, the processor 12 is a control processor or other processor of a computerized data entry system for an EMR storage or database system. The processor 12 operates pursuant to stored instructions to perform various acts described herein.

The processor 12 is configured by software or hardware for adaptive medical information input. The processor 12 may be configured to trigger an analysis of electronic records stored on the memory 14 in response to information input into an EMR of a patient. The processor 12 may further be configured to identify additional information indicated as relevant to the potential condition of the patient from the other medical data. The processor 12 may also be configured to generate a request for the identified additional information. The request may be presented on the display 16. A collection of requests may also be presented on the display 16. The processor 12 may be configured to perform an analysis of text elements, text element qualifiers and text element values of received clinical documents, identify clinical concepts in the received documents based on the analysis, generate an inventory of identified concepts, combine clinical concepts to provide concept combinations, and generate the data structure model using the inventory and the concept combinations.

The display 16 is a CRT, LCD, plasma, projector, printer, or other output device for showing an image. The display 16 displays a user interface with an image. The user interface may be for the entry of information, such as information that may be used for triggering an analysis of electronic records stored on the memory 14. The user interface may be for entering information into an EMR, or displaying a graphical model. Clinical documents, forms, or other forms of organized clinical texts may be shown on the display 16. An information structure may also be shown on the display 16

FIG. 4 shows an exemplary EMR 200. Health care providers may employ automated techniques for information storage and retrieval. The use of an EMR to maintain patient information is one such example. As shown in FIG. 4, an exemplary EMR 200 includes information collected over the course of a patient's treatment or use of an institution. The information may be collected using forms, form templates, form sections, or combinations thereof as well as other electronic data collection techniques. The information may include, for example, computed tomography (CT) images, X-ray images, laboratory test results, doctor progress notes, details about medical procedures, prescription drug information, radiological reports, other specialist reports, demographic information, family history, patient information, and billing (financial) information. Any of this information may provide for information related to a potential condition for a patient.

An EMR may include a plurality of data sources, each of which typically reflects a different aspect of a patient's care. Alternatively, the EMR is integrated into one data source. Structured data sources, such as financial, laboratory, and pharmacy databases, generally maintain patient information in database tables. Information may also be stored in unstructured data sources, such as, for example, free text, images, and waveforms. Often, characteristics, such as key clinical findings, are stored within unstructured physician reports, annotations on images or other unstructured data source.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (We) claim:

1. A system for centrally managing clinical data documents that transforms clinical document text of a plurality of different clinical document types into structured clinical information, the system comprising:
an interface for receiving hierarchically organized clinical document text of a plurality of different clinical document types;
a repository of information including clinical concepts and rules determining relationships between clinical concepts comprising text elements, text element qualifiers, and text element values; and
a document processor configured to use said information for analyzing text of the received documents to,
identify clinical concepts in the received documents,
generate an inventory of identified concepts,
combine clinical concepts to provide concept combinations, and
generate an information structure using the inventory and the concept combinations.

2. The system of claim 1, wherein
said document processor is configured to identify clinical concepts by matching clinical concepts in said repository of information to clinical concepts determined from the received documents, and
combine concepts to provide concept combinations by matching at least one of, (a) text elements having the same text element qualifiers and (b) text element qualifiers having the same text element values.

3. The system of claim 2, wherein said document processor is configured to identify the clinical concepts from said received documents using a medical ontology relating clinical terms to clinical concepts.

4. The system of claim 2, wherein said document processor is configured to differentiate concepts of said concept combinations by a hierarchical path in a received hierarchically organized clinical document.

5. The system of claim 1, wherein said document processor is configured to generate an inventory of identified concepts by,
identifying replicated concepts and
generating a map linking individual identified concepts to corresponding concepts in a received hierarchically organized clinical document.

6. The system of claim 1, wherein said rules determining relationships between clinical concepts comprise at least one of,
(a) linking text element qualifiers to elements,
(b) linking a value to a text element qualifier,
(c) linking a set of allowable values to a text element qualifier and
(d) linking a parent text element to a child text element and
said text elements comprise at least one vital sign including blood pressure, heart rate, SPO2 blood oxygen saturation, temperature, and electrocardiogram (ECG) data.

7. The system of claim 1, wherein said document processor is configured to generate an information structure by merging concepts of a previously generated structure and concepts of a received hierarchically organized clinical document.

8. The system of claim 7, wherein said document processor is configured to merge said concepts of said previously generated structure and concepts of said received hierarchically organized clinical document by performing logical union of sets of elements.

9. The system of claim 1, wherein said document processor is configured to generate a logical expression string of concepts and logical operators representing said information structure.

10. The system of claim 1, wherein the received hierarchically organized clinical document text comprises clinical questions and answers.

11. The system of claim 1, wherein said information comprises a centralized repository of normalized clinical concepts and rules.

12. The system of claim 1, wherein said information structure is hierarchical and said document processor is configured to generate a map linking an individual element to a location in the hierarchical information structure.

13. The system of claim 1, including a logic analyzer configured to analyze a received hierarchically organized clinical document structure by,
classifying said identified concepts into categories having similar properties, and
performing consistency checking on values of similar elements and element qualifiers.

14. A method for managing clinical data documents, the method comprising:
receiving, by a processor, hierarchically organized clinical document text of a plurality of different clinical documents comprised of text elements, text element qualifiers, and text element values;
performing, by the processor, an analysis of the text elements, the text element qualifiers and the text element values of the received clinical documents;
identifying, with the processor, clinical concepts in the received documents based on the analysis;
generating, by the processor, an inventory of identified concepts, combining, by the processor, clinical concepts to provide concept combinations; and
generating, by the processor, a data structure model using the inventory and the concept combinations.

15. The method of claim 14, wherein the performing an analysis comprises applying a medical ontology to at least one of the text elements, the text element qualifiers and the text element values, and
the combining clinical concepts comprises grouping the inventory of identified concepts based on categories determined from the medical ontology.

16. The method of claim 15, wherein the combining clinical concepts further comprises grouping text element qualifiers from different documents of the plurality of different clinical documents under a same text element based on the determined categories.

17. The method of claim 14, wherein the identifying clinical concepts comprises comparing the text elements, the text element qualifiers and the text element values of different documents of the plurality of different clinical documents.

18. The method of claim 17, wherein the comparing comprises determining a path length of at least one text element of the different documents.

19. The method of claim 18, wherein the combining comprises combining identified concepts in the inventory of identified concepts where the path lengths are similar beyond a predetermined threshold of similarity.

20. The method of claim 14, wherein generating the data structure model comprises including presentation and format rules for clinical documents created using the data structure model.

21. A system for managing clinical data documents, the system comprising:
at least one memory operable to store hierarchically organized clinical document text of a plurality of different clinical documents comprised of text elements, text element qualifiers and text element values, and a data structure model; and
at least one processor configured to:
perform an analysis of the text elements, the text element qualifiers and the text element values of the received clinical documents;
identify clinical concepts in the received documents based on the analysis;
generate an inventory of identified concepts,
combine clinical concepts to provide concept combinations; and
generate the data structure model using the inventory and the concept combinations.

22. The system of claim 21, wherein the processor is further configured compare a determined path length of the text elements, the text element qualifiers or the text element values of different documents of the plurality of different clinical documents to identify clinical concepts of the different documents; and
combine identified concepts in the inventory of identified concepts where the path lengths are similar beyond a predetermined threshold of similarity.
